(19) United States
(12) Patent Application Publication
(10) Pub. No.: US 2026/0006139 A1
(43) Pub. Date: Jan. 1, 2026

(54) SHEET-SENSING SYSTEM

(71) Applicant: KINPO ELECTRONICS, INC., NEW TAIPEI CITY (TW)

(72) Inventors: Tsung-Hua KUO, NEW TAIPEI CITY (TW); Wei-Chun JAU, NEW TAIPEI CITY (TW); Kuan-Ting LIN, NEW TAIPEI CITY (TW)

(21) Appl. No.: 18/811,756

(22) Filed: Aug. 21, 2024

(30) Foreign Application Priority Data
Jun. 28, 2024 (TW) 113124423

(51) Int. Cl. H04N 1/00; G01B 11/14; H04N 1/10

(52) U.S. Cl. CPC H04N 1/00755; G01B 11/14; H04N 1/00708; H04N 1/00734; H04N 1/00782; H04N 1/1061

(57) ABSTRACT

A sheet-sensing system is applied to a sheet and a transparent carrier plate. The sheet is placed on the transparent carrier plate. The sheet-sensing system includes a microcontroller, an infrared-emitting apparatus, and an infrared-receiving apparatus. The sheet and the transparent carrier plate are disposed between the infrared-emitting apparatus and the infrared-receiving apparatus. The microcontroller controls the infrared-emitting apparatus to emit an infrared ray toward the sheet and the transparent carrier plate. The microcontroller uses the infrared-receiving apparatus to receive the infrared ray passing through the transparent carrier plate to determine a boundary of the sheet.

### BACKGROUND OF THE INVENTION

### Technical Field

The technical field relates to a sensing system, and especially relates to a sheet-sensing system.

### Description of Related Art

Many paper-related electronic apparatuses, such as scanners, copiers, printers, and multifunction machines, need to sense the sizes and the boundaries of the papers.

FIG. 1 shows a simplified side view of the first related art paper-sensing method. As shown in FIG. 1, a paper 40 is placed on a glass 50. A plurality of (for example, 8) reflective infrared sensors (for example, a first reflective infrared sensor 60 and a second reflective infrared sensor 62) are fixedly disposed at some specific positions under the glass 50. The reflective infrared sensor emits an infrared ray 64 toward the glass 50 and receives the infrared ray 64 which is reflected, wherein the infrared ray 64 emitted by the first reflective infrared sensor 60 passes through the glass 50 and is reflected by the paper 40, and the infrared ray 64 emitted by the second reflective infrared sensor 62 passes through the glass 50 and is not reflected by any shielding object.

The first reflective infrared sensor 60 has received the infrared ray 64 reflected by the paper 40, but the second reflective infrared sensor 62 has not received the infrared ray 64 reflected by the paper 40. Then, a conversion circuit (not shown in FIG. 1) connected to the reflective infrared sensors may convert energies of the infrared rays 64 into voltages, and based on the change of the voltages, a lookup table may be used to determine the size and the boundary of the paper 40.

The first related art paper-sensing method has several disadvantages: first, using a lot of the reflective infrared sensors increases the cost; second, more space is needed in the electronic apparatus to arrange the reflective infrared sensors; third, the infrared ray 64 is absorbed and is not reflected due to the material and the color of the paper 40 and due to other reasons, which may cause the incorrect determination; fourth, the reflective infrared sensors are fixed at some specific positions, and in order to avoid the space required for the movement of the related art contact image sensor (commonly referred to as CIS) scanning circuit (not shown in FIG. 1), the reflective infrared sensors require the function of the long focal length (50 mm to 70 mm) to sense whether the paper 40 exists, but the longer the focal length, the higher the price, thus increasing the cost of the reflective infrared sensors; fifth, multi-segment cutting determinations are made using the lookup table, and if the size of the paper is not the size specified in the list, the incorrect determination may occur, and additional resources of the software are required to sense the result.

FIG. 2 shows a simplified top view (1) of the second related art paper-sensing method. As shown in FIG. 2, a first reflective infrared sensor 60 and a second reflective infrared sensor 62 disposed under a glass 50 are attached to a related art contact image sensor scanning circuit 66 disposed under the glass 50. Then, FIG. 3 shows a simplified top view (2) of the second related art paper-sensing method. As shown in FIG. 3, when an upper cover (not shown in FIG. 3) of the electronic apparatus is opened, the related art contact image sensor scanning circuit 66 may move from the left side part of the glass 50 to the right side part of the glass 50.

Then, FIG. 4 shows a simplified top view (3) of the second related art paper-sensing method. As shown in FIG. 4, a paper 40 is placed on the glass 50. When the upper cover is closed, the related art contact image sensor scanning circuit 66 may move from the right side part of the glass 50 to the left side until the first reflective infrared sensor 60 senses the rightmost side of the paper 40 using the technique of the first related art paper-sensing method mentioned above.

Finally, FIG. 5 shows a simplified top view (4) of the second related art paper-sensing method. As shown in FIG. 5, the related art contact image sensor scanning circuit 66 may scan from the rightmost side of the paper 40 to the left side of the paper 40. After the scanning is completed, the related art contact image sensor scanning circuit 66 may stop at the left side part of the glass 50.

The second related art paper-sensing method uses a moving distance of the related art contact image sensor scanning circuit 66 moving from the rightmost side of the glass 50 to the rightmost side of the paper 40 to determine the length of the paper 40. If the lengths of two papers 40 are determined to be the same, the signal provided by the second reflective infrared sensor 62 may also be used to determine the different widths of the different papers 40. For example, the sizes of 14 types of the papers 40 may be obtained using the table lookup method, wherein the comparison conditions in the table may include the moving distance, the signal provided by the first reflective infrared sensor 60, and the signal provided by the second reflective infrared sensor 62.

Although the second related art paper-sensing method reduces the number of the reflective infrared sensors, the second related art paper-sensing method still has several disadvantages: first, the second related art paper-sensing method still does not improve the incorrect determination caused by the infrared ray absorbed by the paper 40; second, the multi-segment cutting determinations are still made using the lookup table, so the incorrect determination is still possible, and additional resources of the software are required to sense the result; third, the related art contact image sensor scanning circuit 66 needs to move from the left side part of the glass 50 to the right side part of the glass 50, and then move from the right side part of the glass 50 toward the left to the rightmost side of the paper 40 (which means that the paper 40 is sensed), and finally move from the rightmost side of the paper 40 to the leftmost side of the paper 40 to scan the paper 40, which is very time-consuming and power-consuming overall.

### SUMMARY OF THE INVENTION

In order to solve the above-mentioned problems, an object of the present disclosure is to provide a sheet-sensing system.

In order to achieve the object of the present disclosure mentioned above, the sheet-sensing system of the present disclosure is applied to a sheet and a transparent carrier plate. The sheet is placed on the transparent carrier plate. The sheet-sensing system includes a microcontroller, an infrared-emitting apparatus, and an infrared-receiving apparatus. The infrared-emitting apparatus is electrically connected to the microcontroller. The infrared-receiving apparatus is electrically connected to the microcontroller. Moreover, the sheet and the transparent carrier plate are disposed between the infrared-emitting apparatus and the infrared-receiving apparatus. Moreover, the microcontroller controls the infrared-emitting apparatus to emit an infrared ray toward the sheet and the transparent carrier plate. The microcontroller uses the infrared-receiving apparatus to receive the infrared ray passing through the transparent carrier plate to determine a boundary of the sheet.

The advantages of the present disclosure are: first, the present disclosure may avoid the incorrect determination of the size and the boundary of the sheet caused by the material and the color of the sheet; second, the present disclosure may reduce the moving distance of the infrared-receiving apparatus to reduce the overall scanning time and the power consumption; third, the number of the infrared sensors may be reduced.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a simplified side view of the first related art paper-sensing method.

FIG. 2 shows a simplified top view (1) of the second related art paper-sensing method.

FIG. 3 shows a simplified top view (2) of the second related art paper-sensing method.

FIG. 4 shows a simplified top view (3) of the second related art paper-sensing method.

FIG. 5 shows a simplified top view (4) of the second related art paper-sensing method.

FIG. 6 shows a block diagram of the first embodiment of the sheet-sensing system of the present disclosure.

FIG. 7 shows a simplified top view (1) of the application of the first embodiment of the sheet-sensing system of the present disclosure.

FIG. 8 shows a simplified side view about the first cutting line of FIG. 7 of the present disclosure.

FIG. 9 shows a simplified side view about the second cutting line of FIG. 7 of the present disclosure.

FIG. 10 shows a simplified top view (2) of the application of the first embodiment of the sheet-sensing system of the present disclosure.

FIG. 11 shows a simplified side view about the third cutting line of FIG. 10 of the present disclosure.

FIG. 12 shows a simplified top view (3) of the application of the first embodiment of the sheet-sensing system of the present disclosure.

FIG. 13 shows a block diagram of the second embodiment of the sheet-sensing system of the present disclosure.

FIG. 14 shows a simplified top view (1) of the application of the second embodiment of the sheet-sensing system of the present disclosure.

FIG. 15 shows a simplified side view about the fourth cutting line of FIG. 14 of the present disclosure.

FIG. 16 shows a simplified top view (2) of the application of the second embodiment of the sheet-sensing system of the present disclosure.

FIG. 17 shows a simplified side view about the fourth cutting line of FIG. 16 of the present disclosure.

FIG. 18 shows a simplified top view (3) of the application of the second embodiment of the sheet-sensing system of the present disclosure.

FIG. 19 shows a block diagram of the third embodiment of the sheet-sensing system of the present disclosure.

FIG. 20 shows a simplified top view (1) of the application of the third embodiment of the sheet-sensing system of the present disclosure.

FIG. 21 shows a simplified side view about the fifth cutting line of FIG. 20 of the present disclosure.

FIG. 22 shows a simplified side view about the sixth cutting line of FIG. 20 of the present disclosure.

FIG. 23 shows a simplified top view (2) of the application of the third embodiment of the sheet-sensing system of the present disclosure.

FIG. 24 shows a simplified side view about the sixth cutting line of FIG. 23 of the present disclosure.

FIG. 25 shows a simplified top view (3) of the application of the third embodiment of the sheet-sensing system of the present disclosure.

FIG. 26 shows a simplified side view about the seventh cutting line of FIG. 25 of the present disclosure.

FIG. 27 shows a simplified top view (4) of the application of the third embodiment of the sheet-sensing system of the present disclosure.

FIG. 28 shows a simplified schematic diagram of an embodiment of the light guide member and the receiving area of the present disclosure.

FIG. 29 shows a simplified schematic diagram of FIG. 28 applied to FIG. 10 of the present disclosure.

FIG. 30 shows a simplified schematic diagram of FIG. 28 applied to FIG. 16 of the present disclosure.

FIG. 31 shows a simplified schematic diagram of another embodiment of the light guide member and the receiving area of the present disclosure.

FIG. 32 shows a simplified schematic diagram of still another embodiment of the light guide member and the receiving area of the present disclosure.

FIG. 33 shows a schematic diagram of the diffuse infrared rays of the present disclosure.

FIG. 34 shows a schematic diagram of the direct infrared rays of the present disclosure.

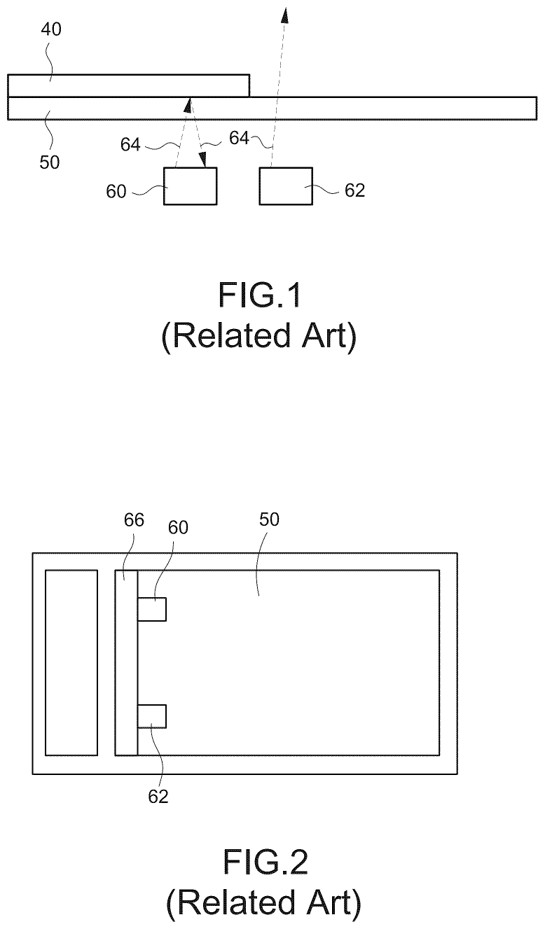

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures. All the following simplified top views of the present disclosure do not show the infrared-emitting apparatus 104, the infrared ray 108, the upper cover 110, and the infrared emitter 112; the same components and symbols have the same or the similar functions in different drawings.

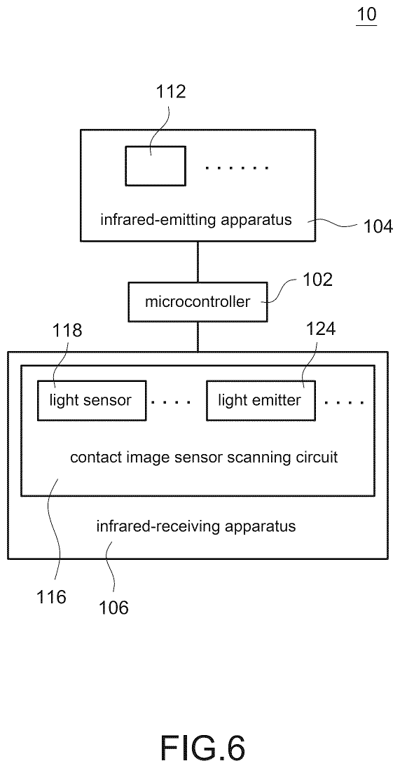

FIG. 6 shows a block diagram of the first embodiment of the sheet-sensing system 10 of the present disclosure. The sheet-sensing system 10 of the present disclosure includes a microcontroller 102, an infrared-emitting apparatus 104, and an infrared-receiving apparatus 106. The infrared-emitting apparatus 104 includes a plurality of infrared emitters 112. The infrared-receiving apparatus 106 includes a contact image sensor (commonly referred to as CIS) scanning circuit 116. The contact image sensor scanning circuit 116 includes a plurality of light sensors 118 and a plurality of light emitters 124.

The microcontroller 102 is electrically connected to the infrared-emitting apparatus 104, the infrared-receiving apparatus 106, the infrared emitters 112, the contact image sensor scanning circuit 116, the light sensors 118, and the light emitters 124. The sheet-sensing system 10 is, for example but not limited to, a scanner, a copier, a printer, or a multifunction machine. The light emitter 124 is, for example but not limited to, a color (for example, including the red, the green, and the blue) light emitting diode.

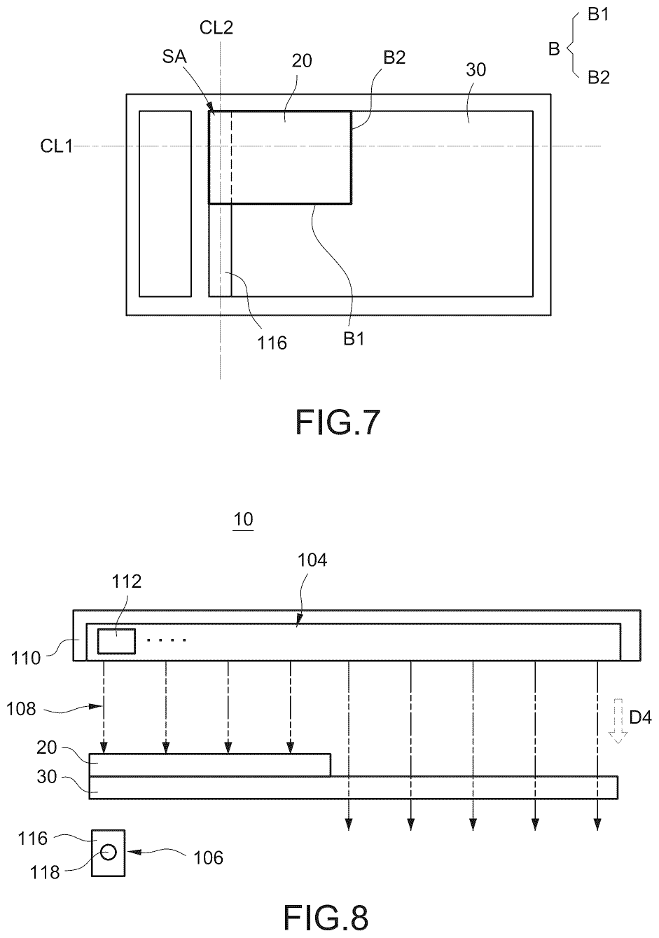

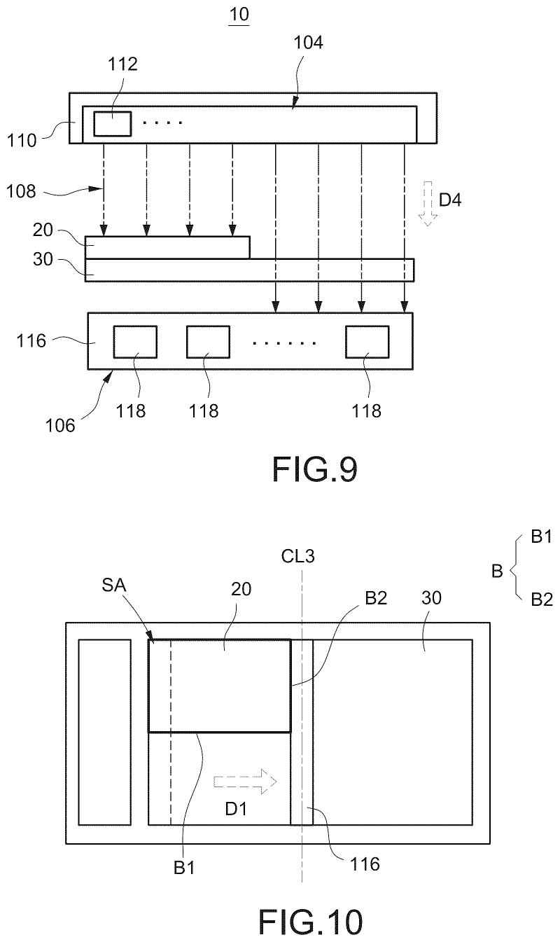

FIG. 7 shows a simplified top view (1) of the application of the first embodiment of the sheet-sensing system 10 of the present disclosure. FIG. 8 shows a simplified side view about the first cutting line CL1 of FIG. 7 of the present disclosure. FIG. 9 shows a simplified side view about the second cutting line CL2 of FIG. 7 of the present disclosure. Please refer to FIG. 6 to FIG. 9 at the same time. The sheet-sensing system 10 of the present disclosure is applied to a sheet 20 (for example, a paper) and a transparent carrier plate 30 (for example, a glass carrier plate). The sheet-sensing system 10 further includes an upper cover 110.

The infrared-emitting apparatus 104 and the infrared emitters 112 embed in the upper cover 110. The sheet 20 is placed on the transparent carrier plate 30. The sheet 20 and the transparent carrier plate 30 are disposed between the infrared-emitting apparatus 104 and the infrared-receiving apparatus 106. The microcontroller 102 may control the infrared emitters 112 to emit a plurality of infrared rays 108 and may simultaneously turn off the light emitters 124 to avoid the interference with the infrared rays 108. The infrared-emitting apparatus 104 emits (for example, vertically emits) the infrared rays 108 along an emitting direction D4 (for example, from top to bottom) toward the sheet 20 and the transparent carrier plate 30; then, the microcontroller 102 uses the infrared-receiving apparatus 106 to receive (for example, vertically receive) the infrared rays 108 passing through the transparent carrier plate 30 (for example, vertically and directly from the top surface of the transparent carrier plate 30 passing through the bottom surface of the transparent carrier plate 30) along the emitting direction D4 to determine a boundary B (which includes a first boundary B1 and a second boundary B2) of the sheet 20, wherein the details are described later.

The microcontroller 102 moves the contact image sensor scanning circuit 116 to a starting area SA and uses the light sensors 118 to receive the infrared rays 108 passing through the transparent carrier plate 30 to determine the first boundary B1 of the sheet 20. As shown in FIG. 9, a part of the infrared rays 108 (namely, the infrared rays 108 on the left side of FIG. 9) are blocked by the sheet 20 and are not transmitted to a part of the light sensors 118 (namely, the light sensors 118 on the left side of FIG. 9), and another part of the infrared rays 108 (namely, the infrared rays 108 on the right side of FIG. 9) are not blocked by the sheet 20 and are transmitted to another part of the light sensors 118 (namely, the light sensors 118 on the right side of FIG. 9), so the contact image sensor scanning circuit 116 reads the relevant images based on whether the light sensors 118 receive the infrared rays 108 and uses the algorithm to find the first boundary B1, thereby determining the width of the sheet 20 (as shown in FIG. 7) on the commonly known Y-axis.

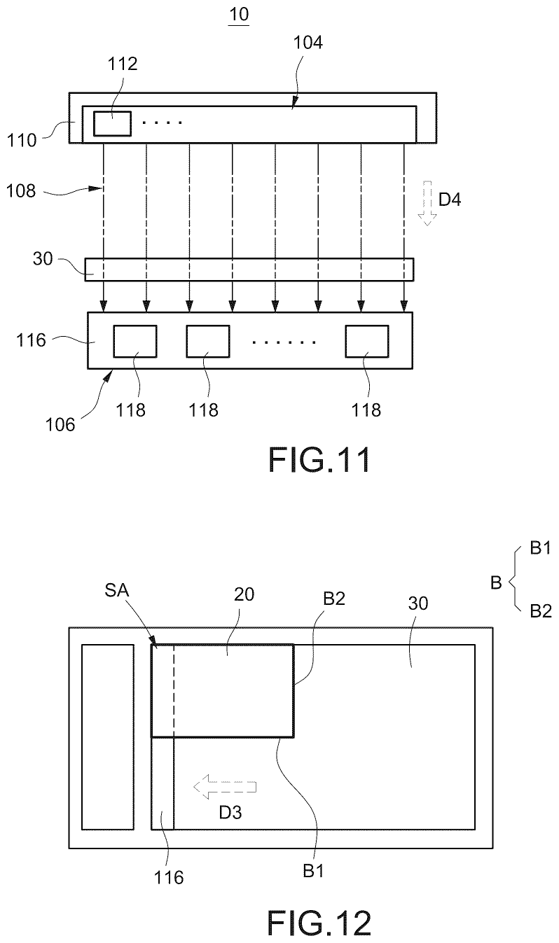

FIG. 10 shows a simplified top view (2) of the application of the first embodiment of the sheet-sensing system 10 of the present disclosure. FIG. 11 shows a simplified side view about the third cutting line CL3 of FIG. 10 of the present disclosure. Please refer to FIG. 6, FIG. 10, and FIG. 11 at the same time. After the first boundary B1 of the sheet 20 is determined, the microcontroller 102 moves the contact image sensor scanning circuit 116 from the starting area SA along a first direction D1 and uses the light sensors 118 to receive the infrared rays 108 passing through the transparent carrier plate 30 to determine the second boundary B2 of the sheet 20. As shown in FIG. 11, the infrared rays 108 are not blocked by the sheet 20 and are transmitted to the light sensors 118. Therefore, the contact image sensor scanning circuit 116 receives the infrared rays 108 through the light sensors 118 to read the relevant images and uses the algorithm to find the second boundary B2, thereby determining the length of the sheet 20 (as shown in FIG. 10) on the commonly known X-axis.

FIG. 12 shows a simplified top view (3) of the application of the first embodiment of the sheet-sensing system 10 of the present disclosure. Please refer to FIG. 6 and FIG. 12 at the same time. After the microcontroller 102 determines the second boundary B2 of the sheet 20, the microcontroller 102 turns on the light emitters 124 of the contact image sensor scanning circuit 116 and may turn off the infrared emitters 112 to avoid the interference with the light emitters 124; then, the microcontroller 102 moves the contact image sensor scanning circuit 116 along a return direction D3 to use the light sensors 118 and the light emitters 124 to scan the sheet 20 to generate a scan image (not shown in the figures); finally, the contact image sensor scanning circuit 116 returns to the starting area SA.

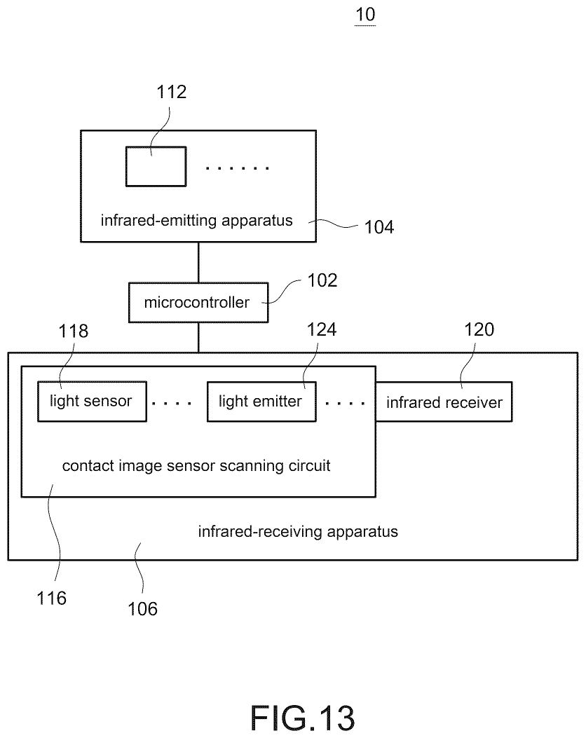

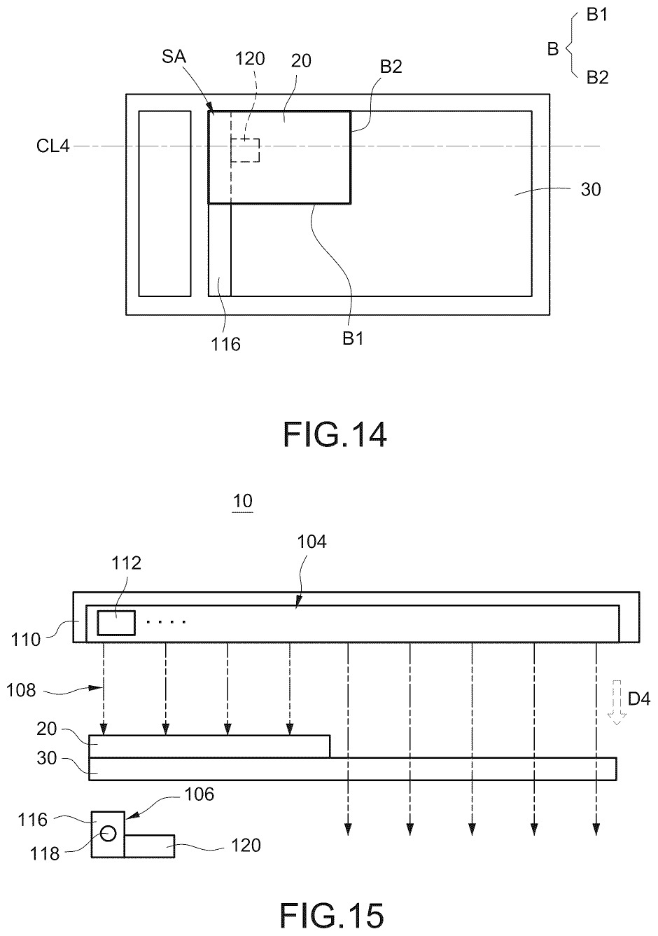

FIG. 13 shows a block diagram of the second embodiment of the sheet-sensing system 10 of the present disclosure. FIG. 14 shows a simplified top view (1) of the application of the second embodiment of the sheet-sensing system 10 of the present disclosure. FIG. 15 shows a simplified side view about the fourth cutting line CL4 of FIG. 14 of the present disclosure. Please refer to FIG. 13 to FIG. 15 at the same time. The infrared-receiving apparatus 106 further includes an infrared receiver 120. The infrared receiver 120 is electrically connected to the microcontroller 102 and attached to the contact image sensor scanning circuit 116 (for example, mounted next to the contact image sensor scanning circuit 116).

The microcontroller 102 moves the contact image sensor scanning circuit 116 to the starting area SA and uses the light sensors 118 to receive the infrared rays 108 passing through the transparent carrier plate 30 to determine the first boundary B1 of the sheet 20; because this content is the same with the content of the first embodiment of the present disclosure mentioned above that “the contact image sensor scanning circuit 116 reads the relevant images based on whether the light sensors 118 receive the infrared rays 108 and uses the algorithm to find the first boundary B1”, so this content is not described again here.

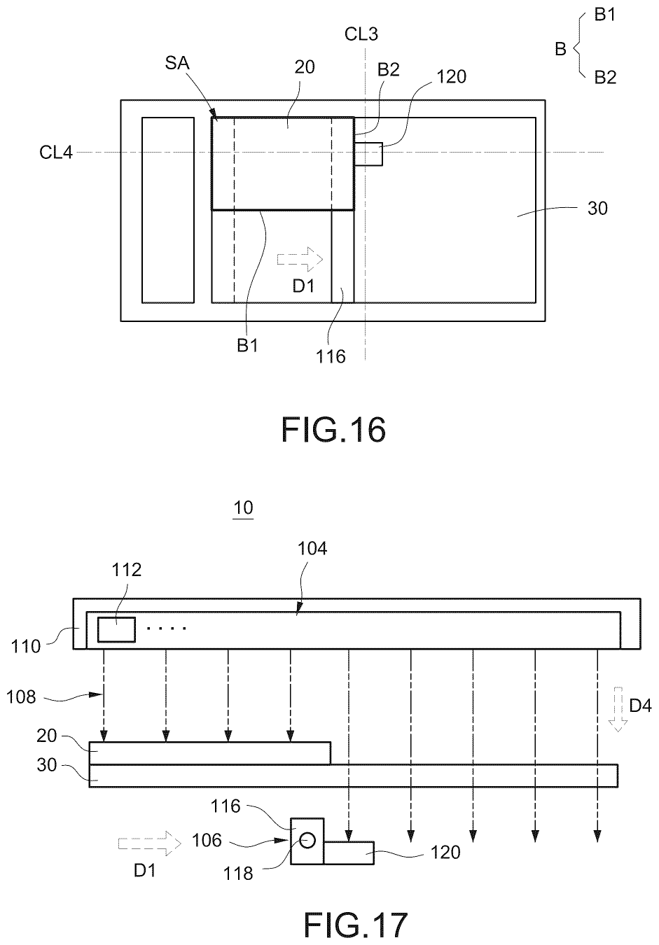

FIG. 16 shows a simplified top view (2) of the application of the second embodiment of the sheet-sensing system 10 of the present disclosure. FIG. 17 shows a simplified side view about the fourth cutting line CL4 of FIG. 16 of the present disclosure. Please refer to FIG. 13, FIG. 16, and FIG. 17 at the same time. After the first boundary B1 of the sheet 20 is determined, the microcontroller 102 moves the contact image sensor scanning circuit 116 from the starting area SA along the first direction D1 until the infrared receiver 120 receives the infrared rays 108 passing through the transparent carrier plate 30; at this time, the second boundary B2 of the sheet 20 is determined.

Namely, when the infrared receiver 120 receives the infrared ray 108 during the movement (at this time, the infrared ray 108 is not blocked by the sheet 20), the infrared receiver 120 informs the microcontroller 102 that the infrared receiver 120 has received the infrared ray 108, and then the microcontroller 102 stops moving the contact image sensor scanning circuit 116; at this time, the second boundary B2 of the sheet 20 is determined.

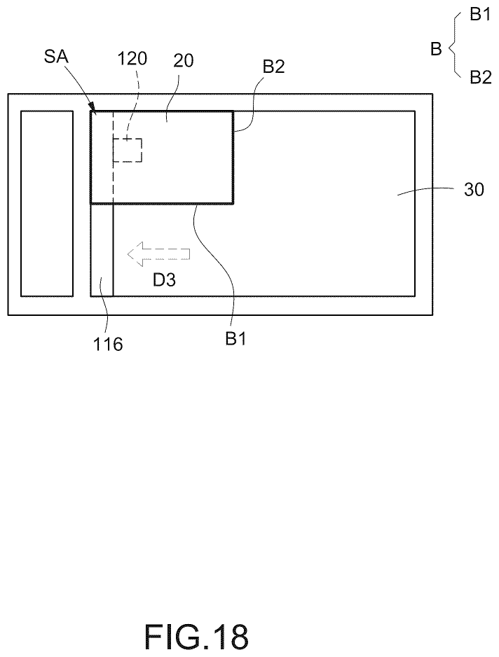

FIG. 18 shows a simplified top view (3) of the application of the second embodiment of the sheet-sensing system 10 of the present disclosure. Please refer to FIG. 13 and FIG. 18 at the same time. After the microcontroller 102 determines the second boundary B2 of the sheet 20, the microcontroller 102 turns on the light emitters 124 of the contact image sensor scanning circuit 116 and may turn off the infrared emitters 112 to avoid the interference with the light emitters 124; then, the microcontroller 102 moves the contact image sensor scanning circuit 116 along the return direction D3 to use the light sensors 118 and the light emitters 124 to scan the sheet 20 to generate a scan image (not shown in the figures); finally, the contact image sensor scanning circuit 116 returns to the starting area SA.

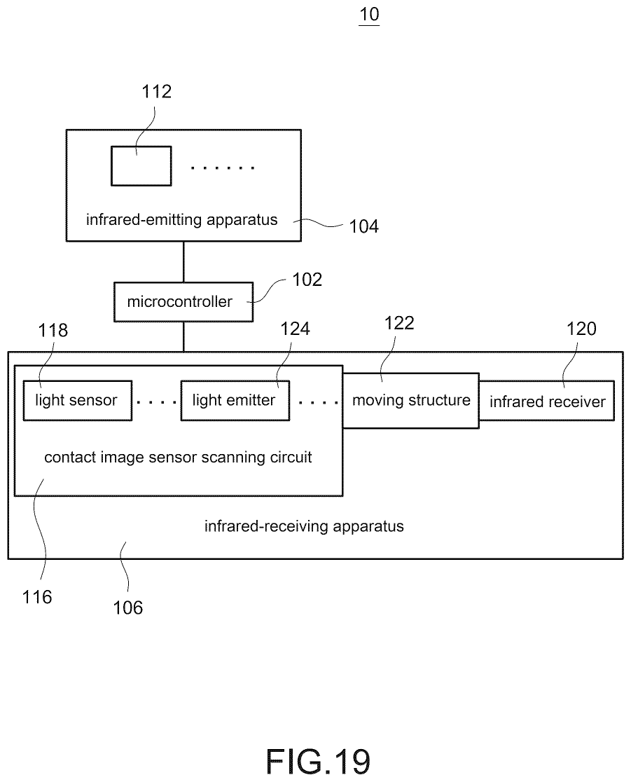

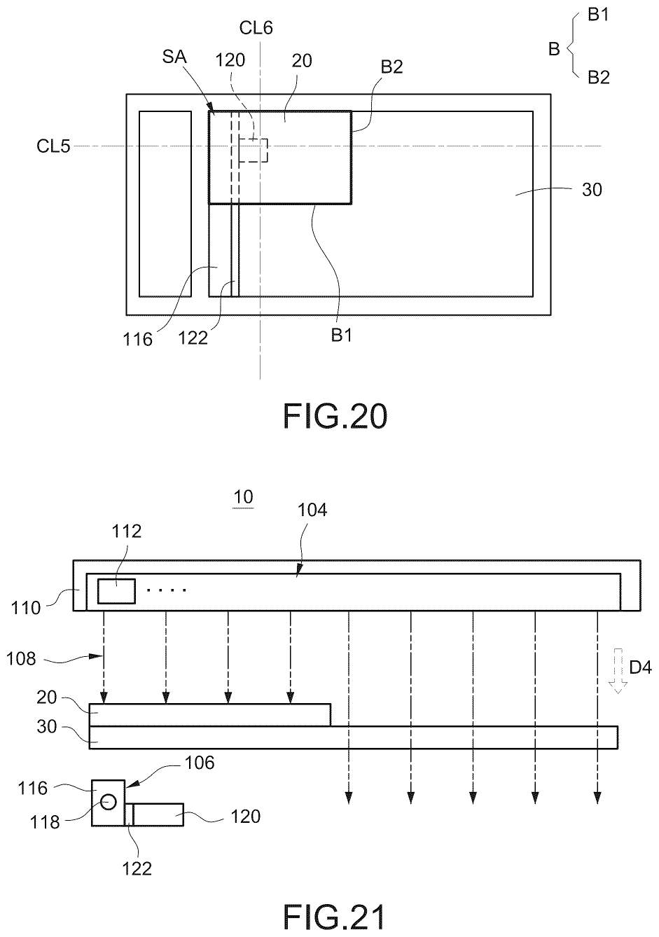

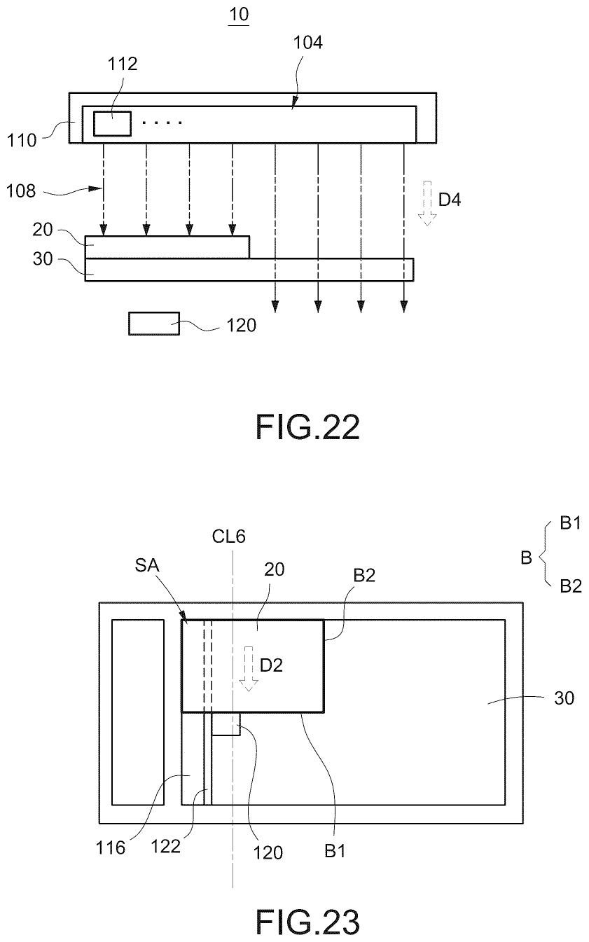

FIG. 19 shows a block diagram of the third embodiment of the sheet-sensing system 10 of the present disclosure. FIG. 20 shows a simplified top view (1) of the application of the third embodiment of the sheet-sensing system 10 of the present disclosure. FIG. 21 shows a simplified side view about the fifth cutting line CL5 of FIG. 20 of the present disclosure. FIG. 22 shows a simplified side view about the sixth cutting line CL6 of FIG. 20 of the present disclosure.

Please refer to FIG. 19 to FIG. 22 at the same time. The infrared-receiving apparatus 106 further includes a moving structure 122 and an infrared receiver 120. The moving structure 122 is electrically connected to the microcontroller 102 and attached to the contact image sensor scanning circuit 116 (for example, mounted next to the contact image sensor scanning circuit 116). The infrared receiver 120 is electrically connected to the microcontroller 102 and attached to the moving structure 122 (for example, mounted next to the moving structure 122). The microcontroller 102 moves the contact image sensor scanning circuit 116 to the starting area SA.

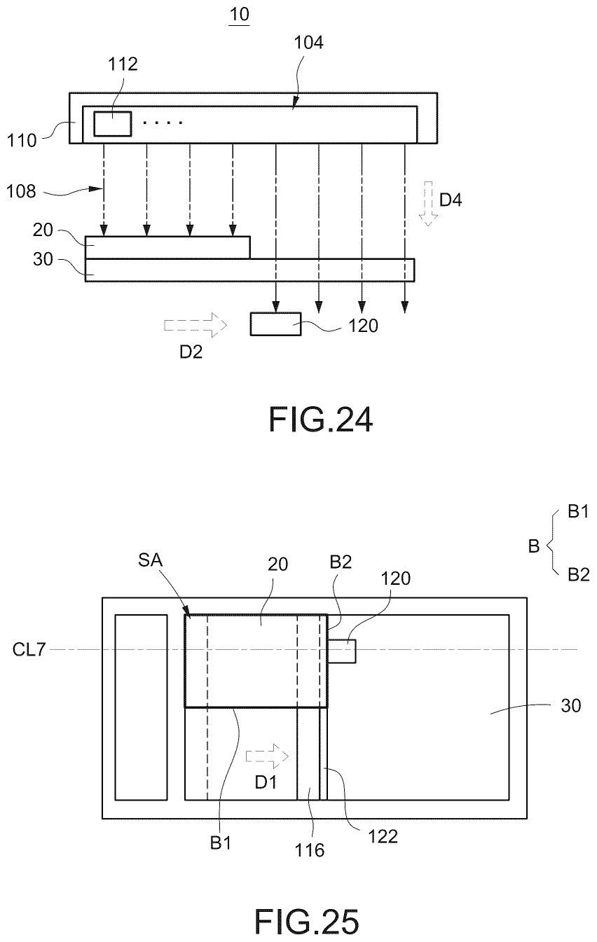

FIG. 23 shows a simplified top view (2) of the application of the third embodiment of the sheet-sensing system 10 of the present disclosure. FIG. 24 shows a simplified side view about the sixth cutting line CL6 of FIG. 23 of the present disclosure. Please refer to FIG. 19, FIG. 23, and FIG. 24 at the same time. After the microcontroller 102 moves the contact image sensor scanning circuit 116 to the starting area SA, the microcontroller 102 controls the moving structure 122 to move the infrared receiver 120 along a second direction D2 until the infrared receiver 120 receives the infrared rays 108 passing through the transparent carrier plate 30; at this time, the first boundary B1 of the sheet 20 is determined.

Namely, when the infrared receiver 120 receives the infrared ray 108 during the movement (at this time, the infrared ray 108 is not blocked by the sheet 20), the infrared receiver 120 informs the microcontroller 102 that the infrared receiver 120 has received the infrared ray 108, and then the microcontroller 102 controls the moving structure 122 to stop moving the infrared receiver 120; at this time, the first boundary B1 of the sheet 20 is determined.

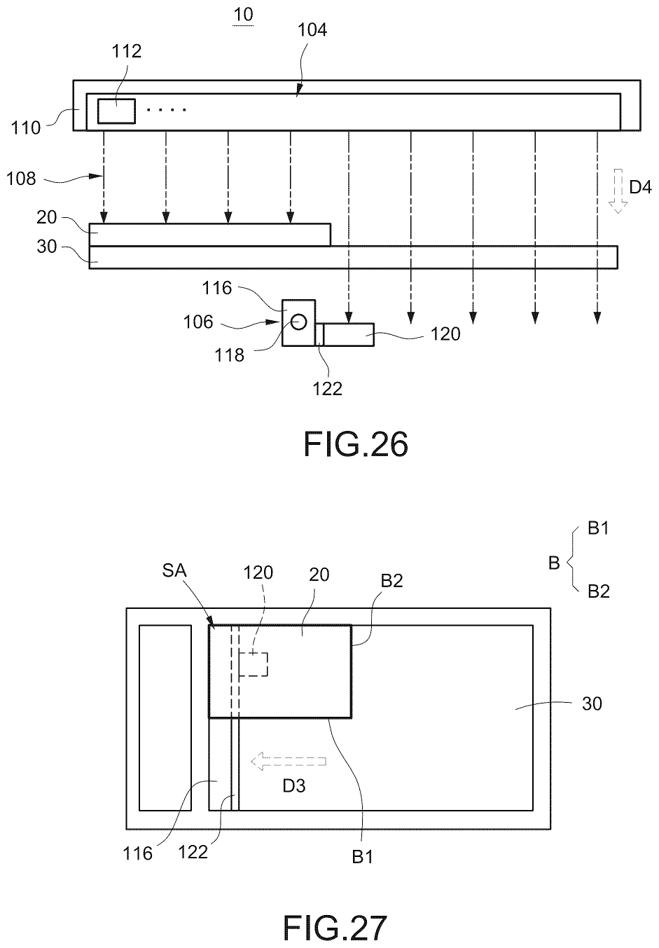

FIG. 25 shows a simplified top view (3) of the application of the third embodiment of the sheet-sensing system 10 of the present disclosure. FIG. 26 shows a simplified side view about the seventh cutting line CL7 of FIG. 25 of the present disclosure. Please refer to FIG. 19, FIG. 25, and FIG. 26 at the same time. After the first boundary B1 of the sheet 20 is determined, the microcontroller 102 controls the moving structure 122 to return the infrared receiver 120 to the position of FIG. 20, and then the microcontroller 102 moves the contact image sensor scanning circuit 116 from the starting area SA along the first direction D1 until the infrared receiver 120 receives the infrared rays 108 passing through the transparent carrier plate 30; at this time, the second boundary B2 of the sheet 20 is determined.

Namely, when the infrared receiver 120 receives the infrared ray 108 during the movement (at this time, the infrared ray 108 is not blocked by the sheet 20), the infrared receiver 120 informs the microcontroller 102 that the infrared receiver 120 has received the infrared ray 108, and then the microcontroller 102 stops moving the contact image sensor scanning circuit 116; at this time, the second boundary B2 of the sheet 20 is determined.

FIG. 27 shows a simplified top view (4) of the application of the third embodiment of the sheet-sensing system 10 of the present disclosure. Please refer to FIG. 19 and FIG. 27 at the same time. After the microcontroller 102 determines the second boundary B2 of the sheet 20, the microcontroller 102 turns on the light emitters 124 of the contact image sensor scanning circuit 116 and may turn off the infrared emitters 112 to avoid the interference with the light emitters 124; then, the microcontroller 102 moves the contact image sensor scanning circuit 116 along the return direction D3 to use the light sensors 118 and the light emitters 124 to scan the sheet 20 to generate a scan image (not shown in the figures); finally, the contact image sensor scanning circuit 116 returns to the starting area SA.

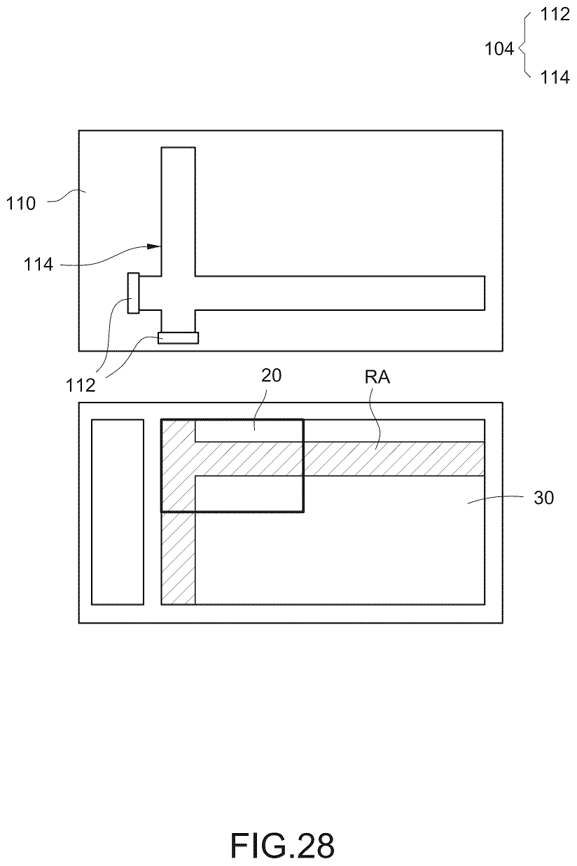

FIG. 28 shows a simplified schematic diagram of an embodiment of the light guide member 114 and the receiving area RA of the present disclosure, wherein the upper cover 110 is displayed as opened, but the receiving area RA is displayed as the infrared irradiation state with the upper cover 110 being closed. The infrared-emitting apparatus 104 further includes a light guide member 114. The light guide member 114 embeds in the upper cover 110 and is used to transmit the infrared rays 108 emitted by the infrared emitters 112 mentioned above, so that the infrared rays 108 cover a receiving area RA of the infrared-receiving apparatus 106. The receiving area RA has to at least include: first, the contact image sensor scanning circuit 116 mentioned above located in the starting area SA mentioned above; and second, the moving range of the contact image sensor scanning circuit 116 for sensing the infrared ray 108 mentioned above, and the moving range of the infrared receiver 120 for sensing the infrared ray 108 mentioned above.

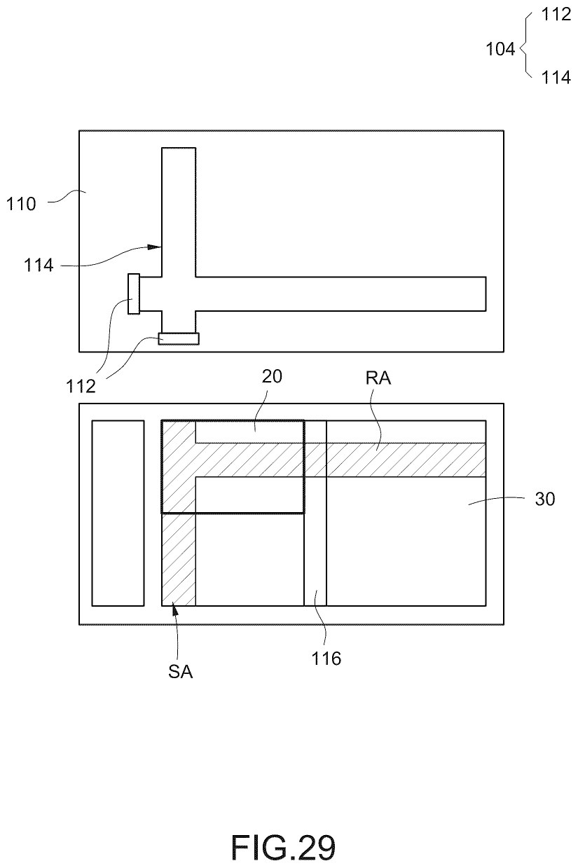

As shown in FIG. 28, the light guide member 114 is a plurality of light guide strips forming a cross shape. FIG. 29 shows a simplified schematic diagram of FIG. 28 applied to FIG. 10 of the present disclosure. After the contact image sensor scanning circuit 116 leaves the starting area SA and before the contact image sensor scanning circuit 116 reaches the position of FIG. 29 of the present disclosure, the infrared rays 108 mentioned above are blocked by the sheet 20, so the contact image sensor scanning circuit 116 may not receive the infrared rays 108 mentioned above; then, the contact image sensor scanning circuit 116 receives the infrared rays 108 through a part of the light sensors 118 mentioned above to read the relevant images and uses the algorithm to find the second boundary B2.

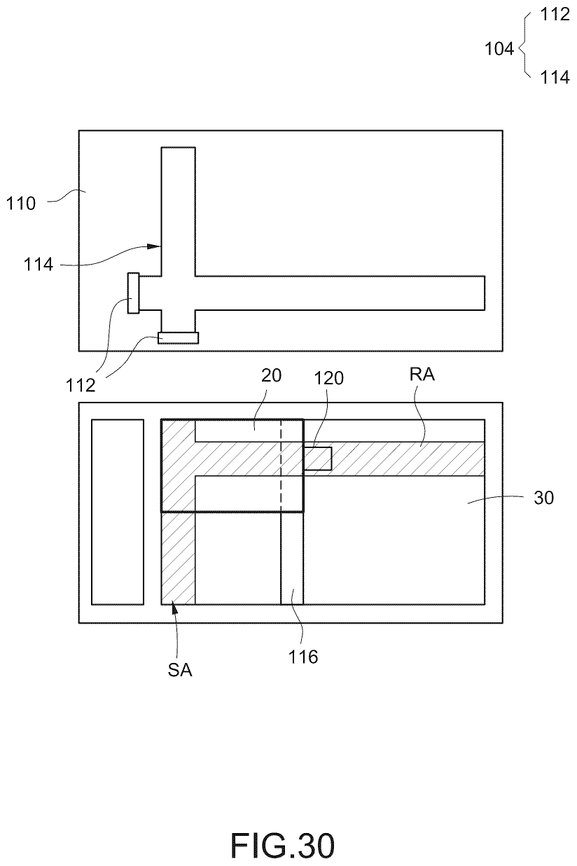

FIG. 30 shows a simplified schematic diagram of FIG. 28 applied to FIG. 16 of the present disclosure. Before the contact image sensor scanning circuit 116 is moved from the starting area SA to the position of FIG. 30, the infrared rays 108 mentioned above are blocked by the sheet 20, so the infrared receiver 120 may not receive the infrared rays 108 mentioned above; then, the infrared receiver 120 receives the infrared rays 108 passing through the transparent carrier plate 30, causing the microcontroller 102 to stop moving the contact image sensor scanning circuit 116 to determine the second boundary B2 of the sheet 20.

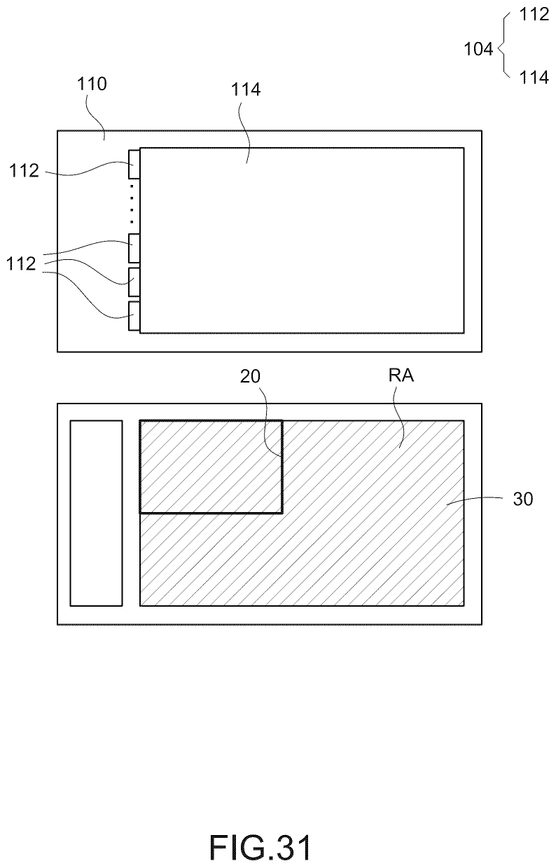

FIG. 31 shows a simplified schematic diagram of another embodiment of the light guide member 114 and the receiving area RA of the present disclosure, wherein the upper cover 110 is displayed as opened, but the receiving area RA is displayed as the infrared irradiation state with the upper cover 110 being closed. As shown in FIG. 31, the light guide member 114 is a light guide plate having the same size as the transparent carrier plate 30. In order to more easily explain the contents of the first embodiment to the third embodiment of the present disclosure mentioned above, the first embodiment to the third embodiment mentioned above use, for example, the full-area range infrared irradiation as shown in FIG. 31.

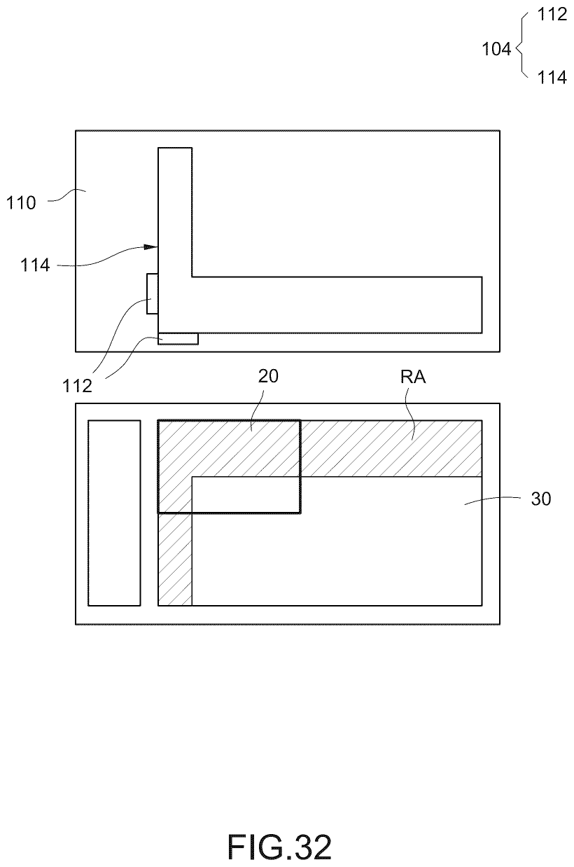

FIG. 32 shows a simplified schematic diagram of still another embodiment of the light guide member 114 and the receiving area RA of the present disclosure, wherein the upper cover 110 is displayed as opened, but the receiving area RA is displayed as the infrared irradiation state with the upper cover 110 being closed. As shown in FIG. 32, the light guide member 114 is a plurality of light guide strips forming an L shape. In addition to the embodiments of FIG. 28, FIG. 31, and FIG. 32, the present disclosure may also embed a considerable number of the infrared emitters 112 throughout the upper cover 110. The description content of the applications of “the coverage areas formed by the infrared rays 108 transmitted by other light guide members 114 of the present disclosure” and “the first embodiment to the third embodiment mentioned above” is similar to the description content mentioned above in FIG. 29 and FIG. 30, which is not described again here.

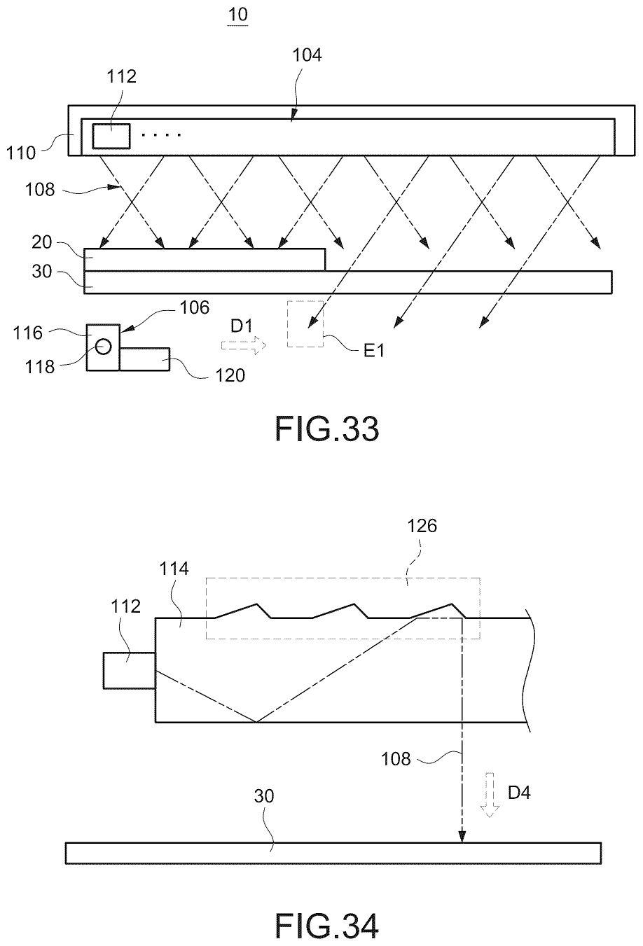

FIG. 33 shows a schematic diagram of the diffuse infrared rays of the present disclosure. The overall installation cost for the diffuse infrared rays is cheaper but an error E1 is generated. However, the error E1 may be calculated, and the software may be used to adjust the moving distance of the contact image sensor scanning circuit 116 to improve the error E1. FIG. 34 shows a schematic diagram of the direct infrared rays of the present disclosure. A special structure 126 (which is micron-level) inside and on the surface of the light guide member 114 is used for the direct infrared rays to enable the infrared ray 108 to be emitted vertically toward the transparent carrier plate 30, thereby avoiding the error E1 shown in FIG. 33, but the overall installation cost for the direct infrared rays is more expensive.

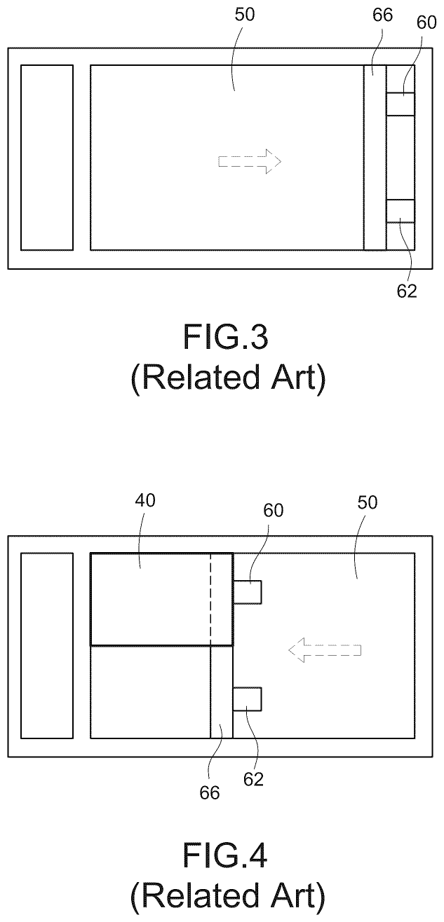

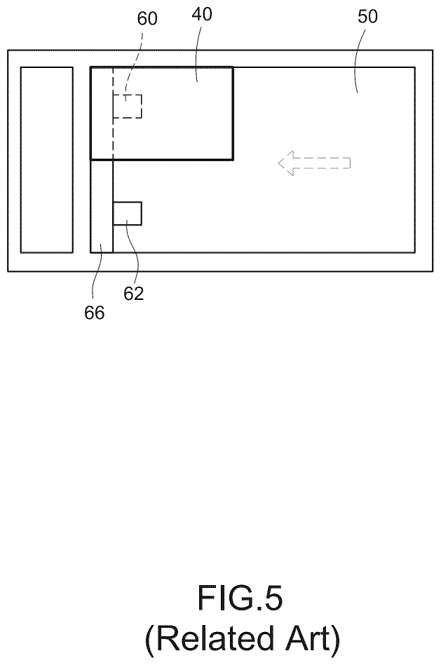

Please refer to FIG. 2 to FIG. 5 again; it may be seen from FIG. 2 to FIG. 5 that the related art contact image sensor scanning circuit 66 has moved almost twice the length of the glass 50. However, for example, as shown in FIG. 14, FIG. 16, and FIG. 18, the moving distance of the contact image sensor scanning circuit 116 of the present disclosure is shorter.

The infrared ray 108 of the present disclosure is emitted by the infrared-emitting apparatus 104 above, and then passes through the transparent carrier plate 30, and is received by the infrared-receiving apparatus 106 below (therefore, the present disclosure uses the penetrating infrared rays), so as to avoid the incorrect determination of the size and the boundary of the sheet 20 caused by the material and the color of the sheet 20. The present disclosure determines the size and the boundary of the sheet 20 by whether the infrared ray 108 passes through the sheet 20. The present disclosure may reduce the moving distance of the infrared-receiving apparatus 106 (namely, the contact image sensor scanning circuit 116) to reduce the overall scanning time and the power consumption. The present disclosure determines the size and the boundary of the sheet 20 in a segment-less manner, and may also reduce the number of the infrared sensors.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. A sheet-sensing system applied to a sheet and a transparent carrier plate, the sheet being placed on the transparent carrier plate, the sheet-sensing system comprising:
a microcontroller;
an infrared-emitting apparatus electrically connected to the microcontroller; and
an infrared-receiving apparatus electrically connected to the microcontroller,
wherein the sheet and the transparent carrier plate are disposed between the infrared-emitting apparatus and the infrared-receiving apparatus;
wherein the microcontroller controls the infrared-emitting apparatus to emit an infrared ray toward the sheet and the transparent carrier plate; the microcontroller uses the infrared-receiving apparatus to receive the infrared ray passing through the transparent carrier plate to determine a boundary of the sheet.

2. The sheet-sensing system of claim 1, further comprising an upper cover, wherein the infrared-emitting apparatus embeds in the upper cover.

3. The sheet-sensing system of claim 2, wherein the infrared-emitting apparatus comprises an infrared emitter; the infrared emitter is electrically connected to the microcontroller and embeds in the upper cover; the microcontroller controls the infrared emitter to emit the infrared ray.

4. The sheet-sensing system of claim 3, wherein the infrared-emitting apparatus further comprises a light guide member; the light guide member embeds in the upper cover and is used to transmit the infrared ray emitted by the infrared emitter, so that the infrared ray covers a receiving area of the infrared-receiving apparatus.

5. The sheet-sensing system of claim 4, wherein the light guide member is a light guide plate, or the light guide member is a plurality of light guide strips forming a cross shape or an L shape.

6. The sheet-sensing system of claim 1, wherein the infrared-receiving apparatus comprises a contact image sensor scanning circuit electrically connected to the microcontroller; the contact image sensor scanning circuit comprises a plurality of light sensors electrically connected to the microcontroller.

7. The sheet-sensing system of claim 6, wherein the microcontroller moves the contact image sensor scanning circuit to a starting area and uses the light sensors to receive the infrared ray passing through the transparent carrier plate to determine a first boundary of the boundary of the sheet; the microcontroller moves the contact image sensor scanning circuit from the starting area along a first direction and uses the light sensors to receive the infrared ray passing through the transparent carrier plate to determine a second boundary of the boundary of the sheet.

8. The sheet-sensing system of claim 6, wherein the infrared-receiving apparatus further comprises an infrared receiver; the infrared receiver is electrically connected to the microcontroller and attached to the contact image sensor scanning circuit; the microcontroller moves the contact image sensor scanning circuit to a starting area and uses the light sensors to receive the infrared ray passing through the transparent carrier plate to determine a first boundary of the boundary of the sheet; the microcontroller moves the contact image sensor scanning circuit from the starting area along a first direction until the infrared receiver receives the infrared ray passing through the transparent carrier plate to determine a second boundary of the boundary of the sheet.

9. The sheet-sensing system of claim 6, wherein the infrared-receiving apparatus further comprises a moving structure and an infrared receiver; the moving structure is electrically connected to the microcontroller and attached to the contact image sensor scanning circuit; the infrared receiver is electrically connected to the microcontroller and attached to the moving structure; the microcontroller moves the contact image sensor scanning circuit to a starting area, and controls the moving structure to move the infrared receiver along a second direction until the infrared receiver receives the infrared ray passing through the transparent carrier plate to determine a first boundary of the boundary of the sheet; the microcontroller moves the contact image sensor scanning circuit from the starting area along a first direction until the infrared receiver receives the infrared ray passing through the transparent carrier plate to determine a second boundary of the boundary of the sheet.

10. The sheet-sensing system of claim 6, wherein the contact image sensor scanning circuit further comprises a plurality of light emitters electrically connected to the microcontroller; after the microcontroller determines the boundary of the sheet, the microcontroller moves the contact image sensor scanning circuit along a return direction to use the light sensors and the light emitters to scan the sheet.
